(19) United States
(12) Patent Application Publication
(10) Pub. No.: US 2010/0212924 A1
(43) Pub. Date: Aug. 26, 2010

(54) WHEEL CYLINDER BRAKE ADJUSTER

(76) Inventor: Lai-Chen LIU, Taiping City (TW)

Correspondence Address: EGBERT LAW OFFICES, 412 MAIN STREET, 7TH FLOOR, HOUSTON, TX, 77002, US

(21) Appl. No.: 12/390,443

(22) Filed: Feb. 21, 2009

(51) Int. Cl. F16D 65/38

(52) U.S. Cl. 173/218

(57) ABSTRACT

The present invention provides a wheel cylinder brake adjuster. The main body of the adjuster has an actuating cylinder, a front seat, a rear seat, an intake handle and a baffle plate. There is a thrust set, and an assembly ring surface arranged at a rear end of the rear seat. First and second intake holes are arranged at intervals on the assembly ring surface. An air path switching ring is placed on the assembly ring surface. The first and second air holes are arranged at intervals on the inner ring surface and have interiors interconnected via a draining space. A pressure release state is made possible when the air path switching ring is rotated to the first rotation position. A plurality of spacing support parts are supported between the inner ring surface and assembly ring surface so that a spaced air leakage space is normally formed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a wheel cylinder brake adjuster, and more particularly to an innovative wheel cylinder brake adjuster with an intake/discharge switching mechanism.

2. Description of Related Art Including Information Disclosed Under 37 CFR 1.97 and 37 CFR 1.98

The wheel cylinder brake adjuster is a special tool used for replacement of braking lining. With high-pressure air as a driving source, a push rod in the mechanism is driven to press down on the wheel cylinder brake, thus releasing the braking lining for easy removal and replacement. Moreover, the pressure accumulated in the wheel cylinder brake adjuster can be released and discharged, enabling the user to manually pull back the push rod.

Given the different patterns of a typical wheel cylinder brake adjuster, there is still a big room for improvement on the structural assembly, especially the intake/discharge switching mechanism. Particularly, there is room for improvement to resolve the shortcomings of conventional products such as excessive components, inconvenient assembly and operation.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the unique present invention, there are first and second intake holes arranged at intervals on the assembly ring surface of the rear seat in conjunction with an air path switching ring of the first and second air holes. The support parts are arranged between the inner ring surface and assembly ring surface to form a spaced air leakage space. As the pressure release and air discharge of the wheel cylinder brake adjuster is realized by the spaced air leakage space between the inner ring surface and assembly ring surface, without the need of additional discharge valves, the users can switch the intake/discharge state by rotating forwardly/inversely the air path switching ring, so the entire wheel cylinder brake adjuster allows users to operate the intake/discharge switching mechanism simply and conveniently with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the preferred embodiment of the present invention.

FIG. 2 shows a partially exploded perspective view of the preferred embodiment of the present invention.

FIG. 3 shows a partially assembled perspective view of the preferred embodiment of the present invention.

FIG. 4 shows a perspective view of the operation of the present invention, wherein the wheel cylinder brake adjuster is used to adjust the wheel cylinder brake.

FIG. 5 shows a simple perspective view of the intake path of the wheel cylinder brake adjuster of the present invention.

FIG. 6 shows a simple perspective view of pressure release path of the wheel cylinder brake adjuster of the present invention.

FIG. 7 shows a perspective view of the present invention with an auxiliary discharge hole is laterally arranged on the assembly ring surface of the rear seat.

FIG. 8 shows a sectional view of the flow path of the mechanism disclosed in FIG. 7.

### DETAILED DESCRIPTION OF THE INVENTION

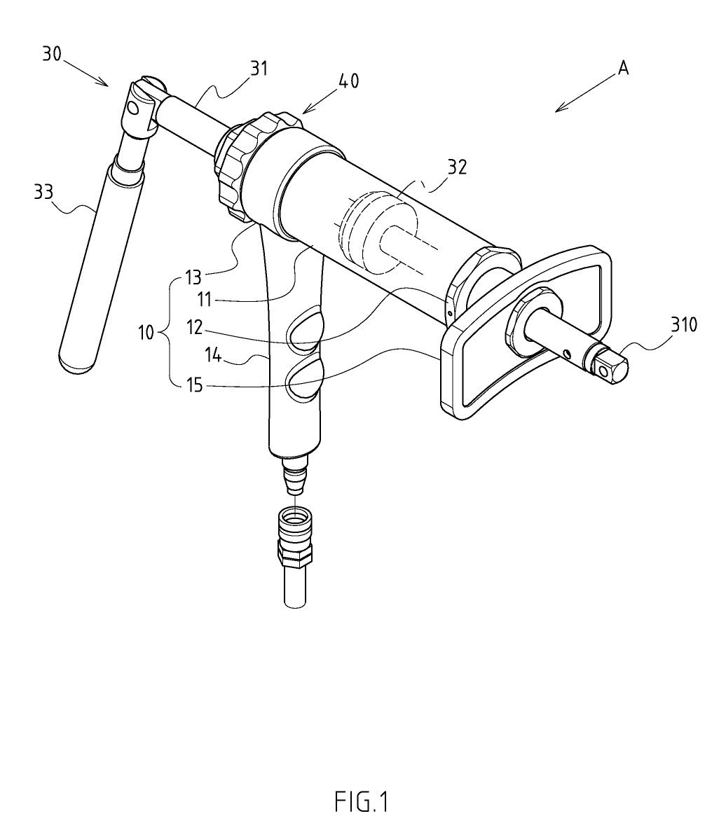

FIGS. 1-3 depict preferred embodiments of a wheel cylinder brake adjuster of the present invention. The embodiments are provided only for explanatory purposes with respect to the claims.

The wheel cylinder brake adjuster A comprises a main body 10, containing an actuating cylinder 11, a front seat 12, a rear seat 13, an intake handle 14 and a baffle plate 15. The front seat 12 and rear seat 13 are separately sealed on the front and rear ends of the actuating cylinder 11. The front and rear seats 12, 13 are provided with corresponding push rod holes 120, 130, while the intake handle 14 is linked to the bottom of the rear seat 13. An intake path 140 is arranged in the intake handle 14. The baffle plate 15 is transversely arranged on the front end of the front seat 12.

The invention further comprises an assembly ring surface 20, which is arranged circularly at the rear end of the rear seat 13.

There is a first intake hole 21, which is arranged onto the assembly ring surface 20. The interior of the first intake hole 21 is vertically linked to the interior of the intake path 140 of the intake handle 14.

There is a second intake hole 22, which is arranged onto the assembly ring surface and co-axially configured with the first intake hole. The interior of the second intake hole 22 is linked to the interior of the actuating cylinder 11.

A thrust set 30 includes a push rod 31, a piston 32 and a revolving handle 33. The piston 32 is limited in the actuating cylinder 11, and the central portion of the push rod 31 is co-axially fixed on the piston 32. The front and rear ends of the push rod 31 penetrate separately the push rod holes 120, 130 on the front and rear seats 12, 13 of the main body 10. In the front of the push rod 31, an inserting portion 310 of quadrangular shape is provided, whilst the revolving handle 33 can be connected to the rear end of the push rod 31.

An air path switching ring 40 is placed on the assembly ring surface 20 of the rear seat 13 for rotating at the first and second rotation positions within a set range of angle. The air path switching ring 40 is provided with an inner ring surface 41 corresponding to the assembly ring surface 20. A first air hole 411 and a second air hole 412 are arranged at intervals on the inner ring surface 41, and the interiors of first and second air holes 411, 412 are interconnected by a draining space 413.

There is an assembly locating member 50, enabling air path switching ring 40 to be located securely on the assembly ring surface 20 of the rear seat 13. The assembly locating member 50 of the preferred embodiment comprises: a cylinder 51 and an elastic part 52. A male threaded portion 53 is fitted on the interior of the cylinder 51, so that a female threaded portion 131 is arranged on the push rod hole 130 of the rear seat 13. A through-hole 54 is provided within the cylinder 51 for the penetration of the push rod 31 of the thrust set 30. An internal seal ring 55 is assembled on the inner wall of the cylinder 51 for mating with the push rod 31. At the exterior of the cylinder 51, an expanded retaining flange 56 corresponds to the external surface of air path switching ring 40. The elastic part 52 is assembled between the expanded retaining flange 56 and the external surface of air path switching ring 40. Moreover, a plurality of external stop rings 57 is arranged externally on the cylinder 51 for mating with the push rod hole 130 and inner wall of air path switching ring 40.

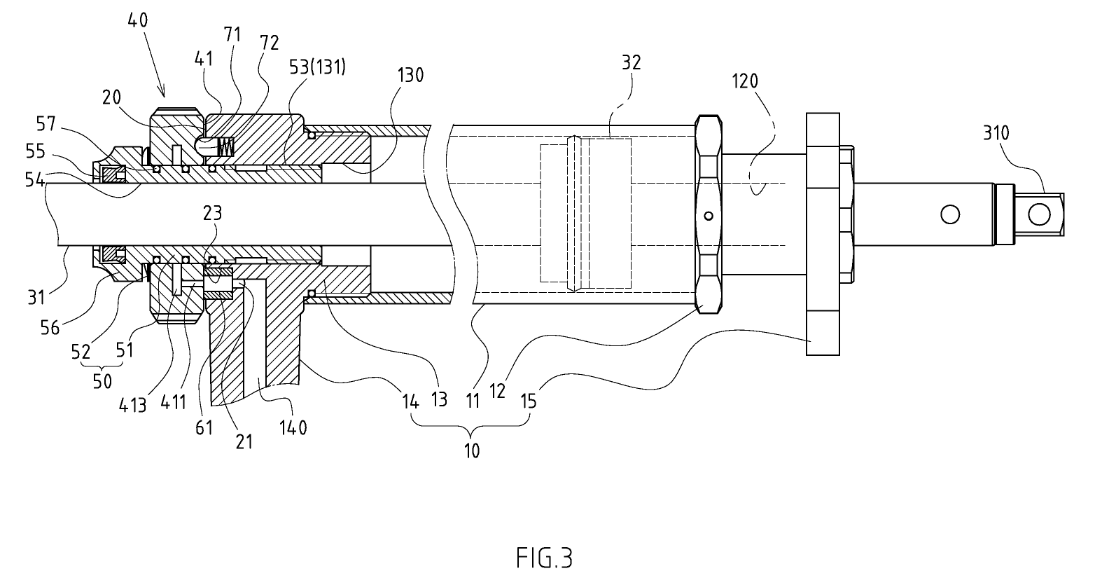

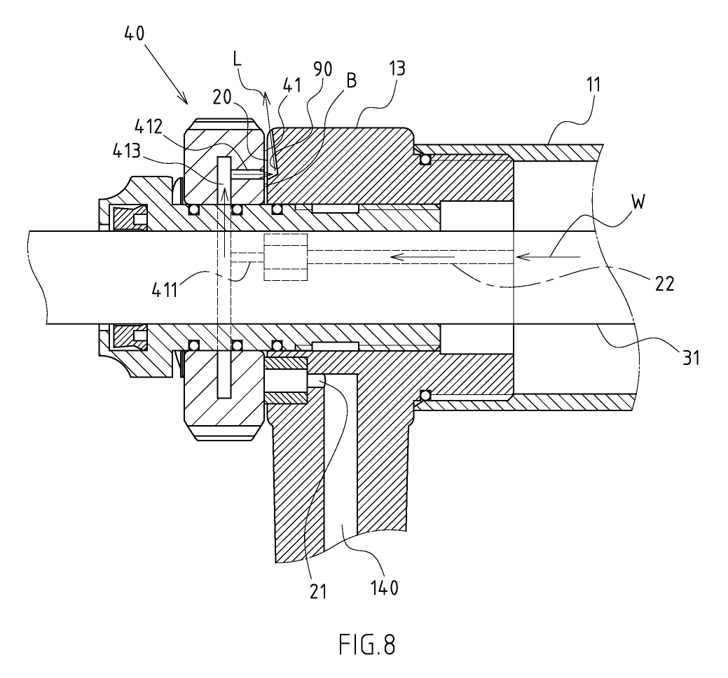

A plurality of spacing support parts 61, 62, 63, are supported between the inner ring surface 41 of air path switching ring 40 and assembly ring surface 20 of the rear seat 13, so that a spaced air leakage space B is normally formed between the inner ring surface 41 and assembly ring surface 20 (marked in FIG. 8). The spacing support parts 61, 62, 63 of the present invention are made of elastic sealing materials (e.g. rubber), which are classified into three groups arranged at intervals onto the assembly ring surface 20 of the rear seat 13. Two spacing support parts 61, 62 are designed into a cylinder so that an expanded slot 23 (shown in FIG. 3) is placed in the first and second intake holes 21, 22 of the assembly ring surface 20 for air-tight insertion of the cylindrical support part 61 (also for 62).

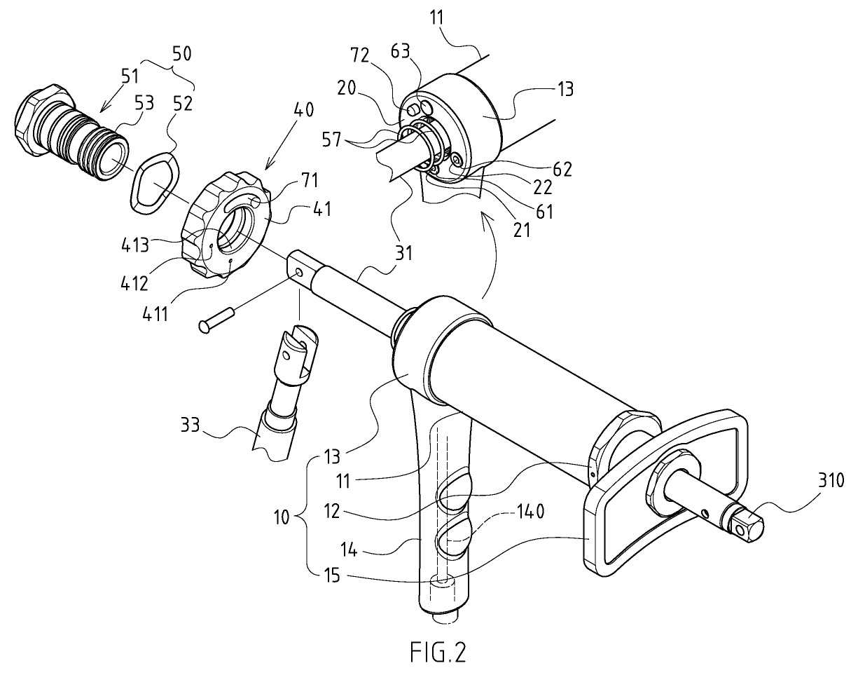

Referring to FIGS. 2-3, a curved groove 71 and a convex cylinder 72 are arranged correspondingly on the inner ring surface 41 of air path switching ring 40 and the assembly ring surface 20 of rear seat 13. The curved groove 71 shifts along with the rotation of air path switching ring 40, and is positioned securely by the blocking of the convex cylinder 72. In this way, air path switching ring 40 can be positioned when rotating to the first/second rotation positions.

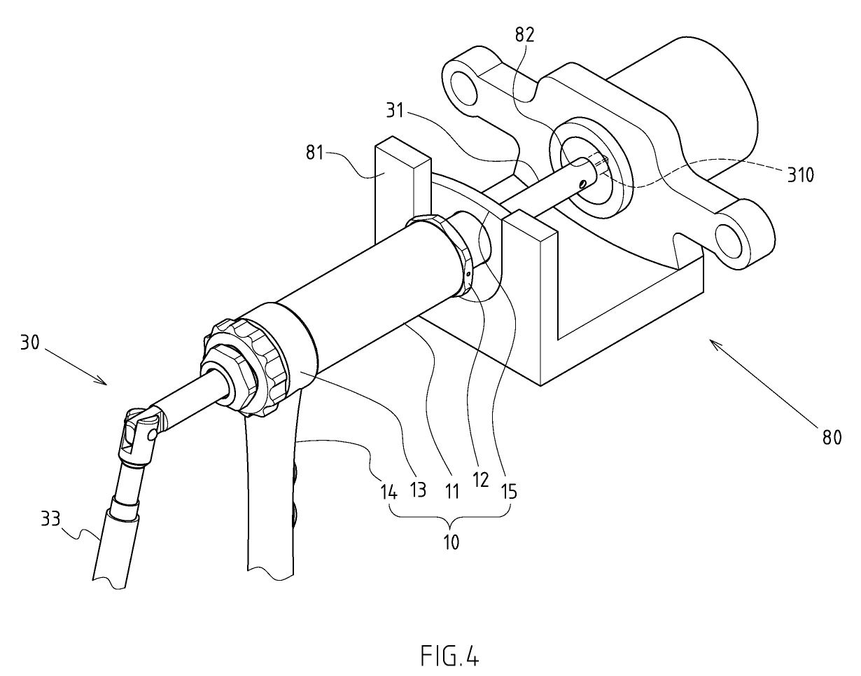

Based on above-specified structures, as shown in FIG. 4, there is view of the operation of the present invention, wherein the wheel cylinder brake adjuster A is used to adjust a wheel cylinder brake 80. The baffle plate 15 of the main body 10 is supported on a corresponding plate 81 of the wheel cylinder brake 80. Then, the inserting portion 310 of the push rod 31 is inserted into a pressing hole 82 of the wheel cylinder brake 80, next the wheel cylinder brake 80 could be adjusted by pneumatically driving the push rod 31.

The key design of the present invention lies in the intake/discharge switching mechanism, which is described below along with the accompanied drawings.

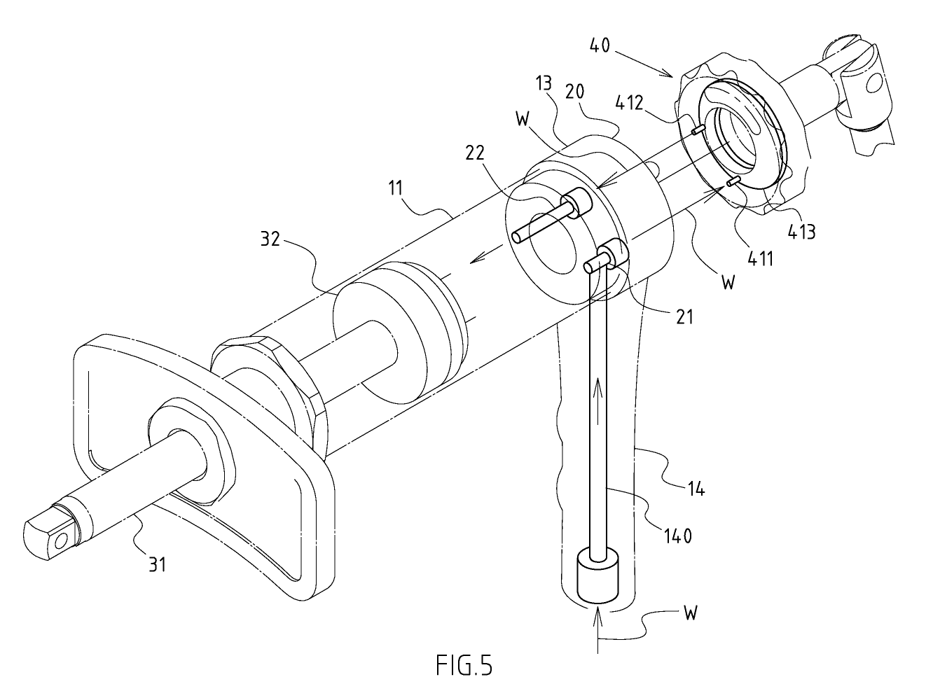

Referring to FIG. 5, there is a view of the operation of the present invention when the air path switching ring 40 is rotated to the first rotation position, wherein the first/second air holes 411, 412 can be correspondingly connected with the first/second intake hole 21, 22 on the assembly ring surface 20 of the rear seat 13. In such a case, air pressure W will be guided into the actuating cylinder 11 via intake path 140 of the intake handle 14, the first intake hole 21, the first air hole 411, the draining space 413, the second air hole 412 and second intake hole 22, thereby actuating the piston 32 to drive the push rod 31.

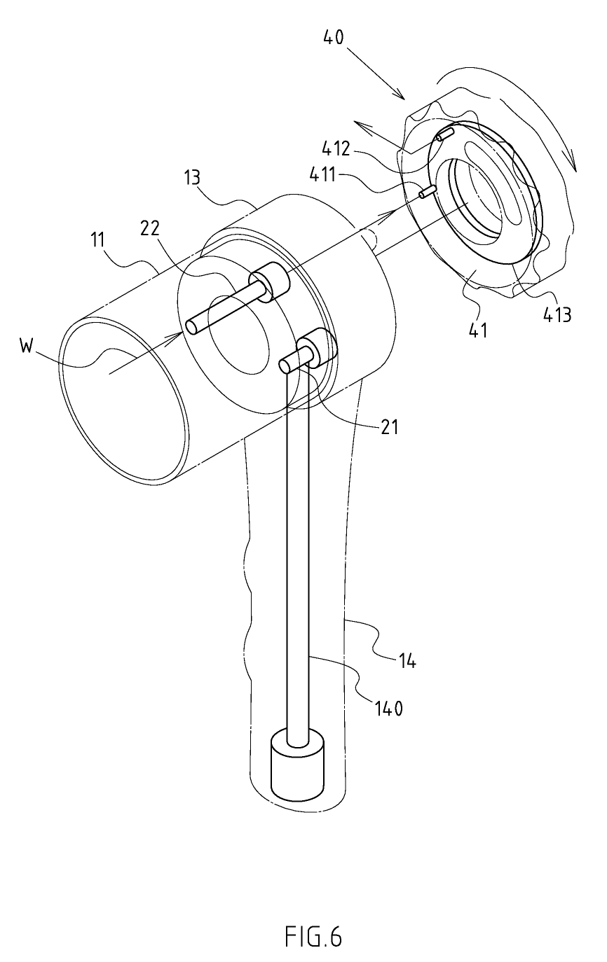

Referring also to FIG. 6, there a view of the operation of the present invention when the air path switching ring 40 is rotated to the second rotation position, wherein the first air hole 411 corresponds to the second intake hole 22, and the second air hole 412 corresponds to the air leakage space B between inner ring surface 41 and assembly ring surface 20. In such a case, air pressure W will be released from air leakage space B via the second intake hole 22, first air hole 411, draining space 413 and second air hole 412.

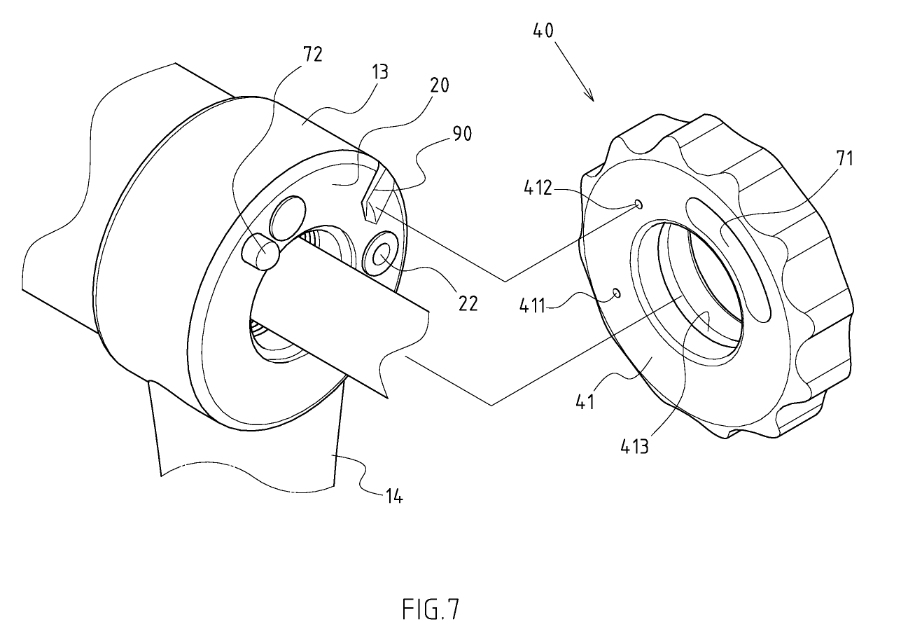

Referring to FIGS. 7-8, at least an auxiliary discharge hole 90 is arranged laterally on the assembly ring surface 20 of the rear seat 13. The auxiliary discharge hole 90 corresponds to the second air hole 412, and the exterior of the auxiliary discharge hole 90 is protruded from one side of the rear seat 13. In the event of pressure release, as shown in FIG. 8, air ejected from the second air hole 412 (marked by arrow L) will be discharged laterally with the guide of auxiliary discharge hole 90, which provides a wider discharge path to ensure smooth air discharge, increase air flow and reduce the noise.

1. A wheel cylinder brake adjuster, comprising:
a main body, being comprised of an actuating cylinder, a front seat, a rear seat, an intake handle and a baffle plate, wherein the front seat and rear seat are separately sealed on front and rear ends of the actuating cylinder, wherein the front and rear seats are provided with corresponding push rod holes, the intake handle being linked to one side of the rear seat and having an intake path arranged therein;
an assembly ring surface, being arranged at rear end of the rear seat;
a first intake hole, being arranged onto the assembly ring surface and having an interior vertically linked to the interior of the intake path of the intake handle;
a second intake hole, being arranged onto the assembly ring surface and co-axially configured with the first intake hole and having an interior linked to the interior of the actuating cylinder;
a thrust set, being comprised a push rod, a piston and a revolving handle, wherein the piston is limited in the actuating cylinder, wherein the central portion of the push rod is co-axially fixed on the piston wherein the front and rear ends of the push rod penetrate separately the push rod holes on the front/rear seat of the main body;
an inserting portion being provided in the front of the push rod, whilst the revolving handle is connected to the rear end of the push rod;
an air path switching ring, being placed on the assembly ring surface of the rear seat for rotating at the first and second rotation positions within a set range of angle and being provided with an inner ring surface corresponding to the assembly ring surface, wherein a first air hole and a second air hole are arranged at interval on the inner ring surface, wherein the interiors of first/second air holes are interconnected by a draining space, the first and second air holes being interconnected with the first and second intake holes when air path switching ring is rotated to the first rotation position;
an assembly locating member, enabling air path switching ring to be located securely on the assembly ring surface of the rear seat; and
a plurality of spacing support parts, being supported between the inner ring surface of air path switching ring and assembly ring surface of the rear seat, so that a spaced air leakage space is normally formed between the inner ring surface and assembly ring surface, wherein the first air hole corresponds to the second intake hole, and wherein the second air hole corresponds to the air leakage space when air path switching ring is rotated to the second rotation position.

2. The adjuster defined in claim 1, wherein the spacing support parts are comprised of elastic sealing materials, being classified into three groups arranged at intervals onto the assembly ring surface of the rear seat; and wherein two spacing support parts are formed by a cylinder, an expanded slot being placed in the first and second intake holes of the assembly ring surface for air-tight insertion of the cylindrical support parts.

3. The adjuster defined in claim 1, wherein the assembly locating member comprises a cylinder and an elastic part, said cylinder having a male threaded portion fitted on the interior of the cylinder, so that a female threaded portion is arranged on the push rod hole of the rear seat; wherein a through-hole is provided within the cylinder for the penetration of the push rod of the thrust set; wherein an internal seal ring is assembled on the inner wall of the cylinder for mating with the push rod; wherein at the exterior of the cylinder, an expanded retaining flange corresponds to the external surface of air path switching ring; wherein the elastic part is assembled between the expanded retaining flange and the external surface of air path switching ring; and wherein a plurality of external stop rings is arranged externally on the cylinder for mating with the push rod hole and inner wall of air path switching ring.

4. The adjuster defined in claim 1, wherein a curved groove and a convex cylinder are arranged correspondingly on the inner ring surface of air path switching ring and the assembly ring surface of rear seat, the curved groove shifting along with the rotation of air path switching ring, and being positioned securely by the blocking of the convex cylinder, said air path switching ring being positioned when rotating to the first and second rotation positions.

5. The adjuster defined in claim 1, wherein at least an auxiliary discharge hole is arranged laterally on the assembly ring surface of the rear seat; wherein the auxiliary discharge hole corresponds to the second air hole, the exterior of the auxiliary discharge hole protruding from one side of the rear seat; and wherein, in the event of pressure release, air ejected from the second air hole will be discharged laterally with the guide of auxiliary discharge hole.
